(19) United States
(12) Patent Application Publication
(10) Pub. No.: US 2026/0184431 A1
(43) Pub. Date: Jul. 2, 2026

(54) TURBOMACHINE COMPRISING A PERMANENT-MAGNET ELECTRIC MACHINE FOR POWERING A ROTATING LOAD

(71) Applicant: SAFRAN AIRCRAFT ENGINES, PARIS (FR)

(72) Inventors: Irène BUJON, MOISSY-CRAMAYEL (FR); Adrian FLORESCU, MOISSY-CRAMAYEL (FR)

(73) Assignee: SAFRAN AIRCRAFT ENGINES, PARIS (FR)

(21) Appl. No.: 19/548,472

(22) Filed: Feb. 24, 2026

Related U.S. Application Data
(63) Continuation of application No. PCT/FR2024/051100, filed on Aug. 21, 2024.

(30) Foreign Application Priority Data
Aug. 29, 2023 (FR) 23/09056

(51) Int. Cl. B64D 27/33; H02K 21/28

(52) U.S. Cl. CPC B64D 27/33; H02K 21/28

(57) ABSTRACT

A turbomachine for an aircraft extends along an axis of rotation and includes one part rotating about the axis of rotation and one part fixed in rotation about the axis of rotation relative to the rotating part. The fixed part includes a fan casing. The turbomachine includes at least one permanent magnet synchronous electric machine that includes at least one permanent magnet positioned on the fixed part of the turbomachine and at least one winding positioned on the rotating part of the turbomachine. The at least one permanent magnet is arranged radially around the at least one winding.

### CROSS-REFERENCE TO RELATED APPLICATIONS

This application is a continuation of International Application No. PCT/FR2024/051100, filed on July 21, 2024, which claims priority to and the benefit of FR 23/09056 filed on August 29, 2023. The disclosures of the above applications are incorporated herein by reference.

### FIELD

The present disclosure relates to aircraft turbomachines, and more particularly to a turbomachine.

### BACKGROUND

The statements in this section merely provide background information related to the present disclosure and may not constitute prior art.

In the present disclosure, the term "aircraft turbomachine" refers to a set of turbomachines or gas turbine machines that produce motive power, dedicated to aircraft propulsion and equipped with a nacelle or not. Among these machines, a distinction is made between turbojet engines which provide the thrust desired for propulsion by reaction through the high-speed ejection of gases, and turboshaft engines, in which motive power is provided by the rotation of a drive shaft. For example, turboshaft engines are used as helicopter engines. Turboprop engines (turboshaft engine driving a propeller) are turboshaft engines used as aircraft engines.

Climate change is a major concern for many legislative and regulatory bodies worldwide. Indeed, various restrictions on carbon emissions have been, are being, or will be adopted by various countries. In particular, an ambitious standard applies to both new types of aircrafts and those currently in service, requiring the implementation of technological solutions to bring them into compliance with current regulations. Civil aviation has been actively working for several years now to contribute to the fight against climate change.

Technological research efforts have already led to very significant improvements in the environmental performance of aircrafts. The Applicant considered the factors impacting all phases of design and development to obtain aeronautical components and products that are less energy-intensive, more environmentally friendly, and whose integration and use in civil aviation have moderate environmental impacts, with the aim of improving the energy efficiency of aircrafts.

Consequently, the Applicant is constantly working to reduce its climate impact by using methods and operating virtuous development and manufacturing methods that reduce greenhouse gas emissions as much as possible in order to reduce the environmental footprint of its activity.

This sustained research and development work focuses on new generations of aircraft engines, the weight reduction of aircraft, in particular through the materials used and lighter on-board equipment, the development of the use of electrical technologies to provide propulsion, and, as complements to technological progress, aviation biofuels.

There are devices disposed in a rotating part of a turbomachine, for example a rotor of a turbine, such as a device for controlling a pitch of the blades of a fan, fan blade low-pitch protection devices, de-icing devices for a cone or the fan blades, etc. Such devices can be powered by electrical energy.

To achieve this, it is known to have an electric machine in a fixed part of a turbomachine and to transmit electrical energy to the rotating part. This can be accomplished, for example, using a slip ring. However, such a slip ring can be fragile and require regular maintenance operations.

The fixed part refers to devices of the turbomachine configured to be stationary or fixed in rotation relative to an aircraft on which the turbomachine is installed. The fixed part comprises, for example, the fan casing.

The rotating part refers to devices of the turbomachine configured to be movable in rotation relative to the aircraft on which the turbomachine is installed.

Electrical energy can also be transmitted to the rotating part by a rotating transformer associated with an inverter, resulting in an increase in the mass and volume of the turbomachine. Furthermore, an electromagnetic field generated by the rotating transformer can interfere with measurement devices of the turbomachine, such as a speed sensor or a fan pitch setting sensor.

### SUMMARY

This section provides a general summary of the disclosure and is not a comprehensive disclosure of its full scope or all of its features.

The present disclosure concerns a turbomachine for an aircraft. The turbomachine extends along an axis of rotation and comprises at least: The machine, by using at least one permanent magnet, delivers a variable voltage which varies with a rotational speed and whose effective value and frequency vary with the rotational speed of the rotating part.

one part rotating about the axis of rotation,

one part fixed in rotation about the axis of rotation relative to the rotating part, the fixed part comprising a fan casing,

the turbomachine comprising at least one permanent magnet synchronous electric machine,

the machine comprising at least one permanent magnet positioned on the fixed part of the turbomachine and at least one winding positioned on the rotating part of the turbomachine, the at least one permanent magnet being arranged radially around the at least one winding,

the turbomachine comprising an electrical power network positioned in the rotating part, the electrical power network being connected to the electric machine and being configured to circulate an electric current,

the turbomachine comprising an electrical device positioned on the rotating part and being configured to be powered by the electric current.

Generally, the axial direction corresponds to the direction of the axis of rotation of the turbomachine (or of a disk of the fan), and a radial direction is a direction perpendicular to the axis of rotation.

Furthermore, upstream and downstream are defined with respect to a normal flow direction of gases (upstream to downstream) through the turbomachine.

In some variations, the turbomachine comprises at least one turbine, at least one compressor and at least one fan which are positioned along the axial direction, i.e. linearly along the axis of rotation.

The turbomachine may also comprise a nacelle.

The turbine, compressor, and nacelle comprise elements or devices that form the fixed part of the turbomachine relative to the aircraft, when the turbomachine is fastened to the aircraft via the nacelle. In other words, the fixed part is secured to the nacelle.

The turbine, compressor, and fan comprise elements movable in rotation about the axis of rotation. These elements form the rotating part of the turbomachine. These elements have a relative movement with respect to the nacelle.

By means of gas expansion in a combustion chamber, the turbomachine drives in rotation the axis of rotation on which the rotating part is fastened. The turbomachine also comprises at least one electric machine. The electric machine can be used in generator mode in which it produces electrical energy, or in motor mode in which it consumes energy in order to rotate the axis of rotation.

The motor mode of the electric machine can be used when starting the turbomachine, or during a maintenance operation requiring a rotation of the rotating part of the turbomachine, or even to inject mechanical torque onto a shaft of the turbomachine to which the electric machine is coupled during any flight phase of the aircraft.

More specifically, the machine is a rotary machine that can convert mechanical energy into alternating current electrical energy and vice versa.

The electric machine is synchronous. In other words, the rotating part rotates synchronously with a rotating field of the fixed part. The machine can, for example, be of the permanent magnet synchronous motor (PMSM) type with an external rotor, whose external part, comprising the at least one permanent magnet, is positioned on the fixed part and whose internal part, comprising the at least one winding, is positioned on the rotating part.

The machine according to the present disclosure comprises at least one permanent magnet generating a constant field. The at least one permanent magnet is positioned in the fixed part of the turbomachine. In other words, the permanent magnet is fixed relative to the nacelle and relative to the aircraft when the turbomachine is installed in the aircraft.

The permanent magnet is an inductor of the machine, i.e., the function of the permanent magnet is to induce an electromagnetic field in the rotating part of the machine.

The rotating part of the machine includes at least one winding, which corresponds to an armature. In other words, during rotation, the at least one winding receives an induction from the inductor, the permanent magnet, and transforms it into electricity, and more specifically into a sinusoidal alternating current, within the rotating part of the turbomachine. The at least one winding can refer to an electric coil.

The electric machine therefore directly supplies alternating electric current to the rotating part of the turbomachine on the electrical power network.

The electric current is therefore generated directly in the rotating part by the electric machine.

In the present description, the terms "at least one permanent magnet" refer to at least one pair of north-south permanent magnets.

The electric current generated in the rotating part makes it possible to power an electrical device, also called "function," of the turbomachine, which is also located in the rotating part. This eliminates the need to cause electrical current to pass from the fixed part to the rotating part. The efficiency, weight, and volume of the turbomachine are thus improved.

An electrical function or device is any element of the turbomachine that consumes electricity. The electrically implemented functions of the turbomachine can also be called "electrical loads". A function can carry out a physical action on the turbomachine, such as heating, or a regulation or control action.

For example, the rotating part comprises the functions such as fan pitch control, small-pitch protection, or de-icing of a cone or the fan blades.

For example, de-icing a cone or the fan blades requires an electrical power of approximately 30 kW.

The present disclosure may also include one or more of the following features, taken alone or in combination.

According to one variation, the turbomachine can comprise, on the one hand, a high-pressure spool including a high-pressure compressor and a high-pressure turbine, and on the other hand, a low-pressure spool including a low-pressure compressor and a low-pressure turbine.

According to one variation, the turbomachine also comprises an intermediate spool including an intermediate pressure compressor and an intermediate pressure turbine.

According to one variation, the electric machine is positioned axially between the fan and the compressor.

According to one variation, the electric machine is positioned axially between the fan and a reduction gear box.

According to one variation, the electric machine is positioned between a reduction gear box and the compressor.

Thus, the machine has a higher operating speed and therefore better efficiency.

According to one variation, the at least one electrical power network is electrically connected to an electrical power supply network which is positioned in the fixed part of the turbomachine.

The electrical power supply network corresponds to a general electrical network of the turbomachine, and more generally of the aircraft, which powers functions in the fixed part such as a power supply for the flight controls, wing anti-icing, a power supply for the cabin air conditioning system, lighting of an aircraft cabin, or even a power supply for the cockpit.

Thus, when the electrical power network is connected to the electrical power supply network, the electrical power network comprises two power sources: on the one hand, from the electric machine of the turbomachine, and on the other hand, from the electrical power supply network. There is therefore redundancy in the power sources. The electrical safety of the functions of the rotating part is thus improved.

Furthermore, when an electric current is generated by the electric machine but no function of the rotating part is in operation, the generated electric current can be fed into the electrical power supply network. This makes it possible to provide redundancy of the electrical power supply on the electrical power supply network.

According to one variation, the electrical power network is electrically connected to the electrical power supply network by means of a rotating power transformer.

A rotating transformer allows the transmission of electrical energy by electromagnetic induction between first and second windings positioned respectively on the fixed part and on the rotating part of the turbomachine.

According to one variation, the electrical power network is configured to provide an electric power greater than or equal to 10 kW and less than or equal to 50 kW.

According to one variation, the turbomachine comprises an electrical control network positioned in the rotating part and connected to at least one power controller positioned in the rotating part.

The electrical control network allows the transmission of operating and regulation commands to the various functions of the rotating part.

The power controller generates and regulates the various functions of the rotating part, such as electrical protection or activation management of a function.

According to one variation, the electrical control network is electrically connected to a general regulation network which is positioned in the fixed part.

The general regulation network can be connected to the full authority digital engine controls (FADEC). The general regulation network is a system that interfaces between a cockpit and the turbomachine of the aircraft to provide proper operation of the turbomachine. The FADEC receives all information concerning the operation of the aircraft, or specifically the turbomachine, and controls the various functions based on this information.

A link between the electrical control network and the general regulation network makes it possible to transmit data between the two, but also allows information to be fed back, for example in the event of a failure on the turbomachine, and more particularly on a function of the rotating part of the turbomachine.

According to one variation, the electrical control network is electrically connected to the general regulation network by means of a rotating data transformer.

According to one variation, the turbomachine includes a mechanical element for separating and disconnecting the electric machine from a shaft of the turbomachine.

Indeed, in the event of an electrical failure of the electric machine or the electrical power network, it is desired to have an element that allows the electric machine to be mechanically disconnected.

According to one variation, the mechanical separation element can be positioned on the rotating part of the turbomachine.

According to one variation, the mechanical separation element can be a dog clutch.

According to one variation, the at least one electric machine is positioned inside the fan casing.

Another aspect of the present disclosure relates to an aircraft comprising a turbomachine according to any one of the variations of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference to the accompanying drawings, in which:

FIG. 1 is a representation of an aircraft;

FIG. 2 is a schematic representation of an architecture of a turbomachine according to the present disclosure;

FIG. 3 is a first variation of the present disclosure; and

FIG. 4 is a second variation of the present disclosure;

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

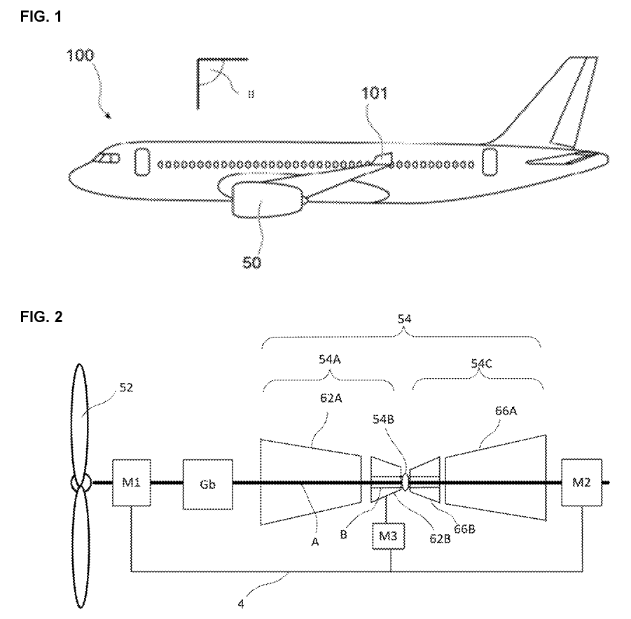

FIG. 1 represents an aircraft 100, in this example an aircraft equipped with two turbomachines 50, in this example two propulsion units or two turbojet engines 50, namely one turbomachine 50 per wing 101. Only one turbomachine 50 and one wing 101 are represented in FIG. 1. According to one variant, the aircraft 100 can be equipped with more than one turbomachine 50 per wing 101, each wing 101 being provided with the same number of turbomachines 50.

FIG. 2 represents a schematic view, in cross-section along plane II of FIG. 1, of an architecture of the turbomachine 50 according to the present disclosure.

The turbomachine 50 comprises a fan 52, which is positioned in a fan casing and a gas generator 54.

In this example, the gas generator 54 comprises, from upstream to downstream, the gases flowing within the turbomachine 50 from upstream to downstream, a compressor 54A (or compressor section 54A), a combustion chamber 54B, and a turbine 54C (or turbine section 54C).

The fan 52 can be driven in rotation by a shaft of the gas generator 54, for example directly by a shaft A of a low-pressure spool, or via a reduction gear box Gb, also called RGB, mechanically coupled to the shaft A of the low-pressure spool. The reduction gear box Gb makes it possible to reduce the rotational speed of the fan 52 relative to that of the shaft A of the low-pressure spool.

The gas generator 54 can be of the twin-spool type and can comprise a low-pressure spool and a high-pressure spool.

The low-pressure spool may comprise a low-pressure compressor 62A coupled in rotation with a low-pressure turbine 66A via the low-pressure shaft A.

The high-pressure spool may comprise a high-pressure compressor 62B disposed downstream of the low-pressure compressor 62A and upstream of the combustion chamber 54B, and a high-pressure turbine 66B, disposed downstream of the combustion chamber 54B and upstream of the low-pressure turbine 66A, and coupled in rotation with the high-pressure compressor 62B via a high-pressure shaft B.

The compressor 54A of the gas generator 54 may comprise the low- and high-pressure compressors 62A and 62B. The turbine 54C of the gas generator 30 may comprise the low- and high-pressure turbines 66B and 66A.

FIG. 2 is schematic, each compressor and each turbine being able to have one or several stages, each stage comprising a moving wheel and a stator.

The turbomachine 50 comprises elements movable in rotation, hereafter referred to as rotating part Pt, about an axis of rotation, in a nacelle of the turbomachine 50. The nacelle is configured to be fastened on the aircraft 100. Hereafter, the fixed part Pf refers to elements of the high-pressure spool, the low-pressure spool which are fixed relative to the nacelle.

FIG. 2 illustrates the positioning of the electric machines M1, M2, M3 connected to an electrical power supply network 4 corresponding to a general electrical network of the turbomachine, and more generally of the aircraft 100. The electrical power supply network 4 powers functions in the fixed part Pf such as a power supply for the flight controls, wing anti-icing, a power supply for the cabin air conditioning system, lighting of an aircraft cabin, or even a power supply for the cockpit.

A first electric machine M1 is positioned between the fan 52 and the compressor 54A of the gas generator 54. More specifically, the electric machine M1 is positioned axially (along the axis of rotation A) between the fan 52 and the reduction gear box Gb, or alternatively positioned axially between the reduction gear box Gb and the compressor 54A.

The electric machine M1 will be described in more detail with reference to FIG. 4.

A second electric machine M2 is positioned downstream of the turbine 54C and a third electric machine M3 is positioned at the high-pressure compressor 62B.

The electric machines M1, M2 and M3 produce an electric current intended to be consumed in the rotating part Pt of the turbomachine 50 or to be transmitted on the electrical power supply network 4.

Having several electric machines M1, M2, M3 makes it possible to reduce the size of each of the electric machines M1, M2, M3. They can therefore be more easily integrated into the overall architecture of the turbomachine. Another advantage of positioning several electric machines M1, M2, M3 is, on the one hand, to have a redundancy and therefore better overall reliability of the electrical power supply network 4, and on the other hand, to be able to install simple electric machines.

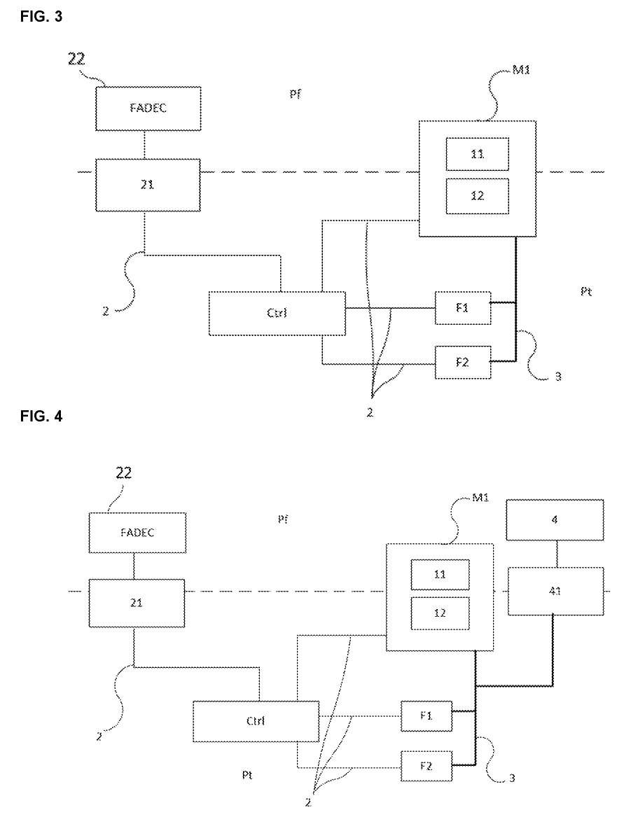

More particularly, a first variation of the turbomachine 50 according to the present disclosure is described with reference to FIG. 3.

The turbomachine 50 comprises a permanent magnet 11 synchronous electric machine M1 mechanically coupled to a shaft of the gas generator 54 such as the low-pressure shaft A. When the electric machine M1 operates in machine mode, it takes mechanical torque from the shaft to which it is coupled so as to convert mechanical energy into alternating current electrical energy.

The electric machine M1 comprises elements positioned on the rotating part Pt and others on the fixed part Pf of the turbomachine.

On the fixed part Pf, the electric machine M1 comprises at least one permanent magnet 11 generating a constant field. The permanent magnet 11 is fixed relative to the nacelle and relative to the aircraft 100 when the turbomachine 50 is installed on it. The permanent magnet 11 is an inductor of the machine, i.e., the function of the permanent magnet 11 is to induce an electromagnetic field on the elements of the rotating part Pt of the electric machine.

According to one variation, the at least one permanent magnet 11 is arranged around the rotating part Pt.

According to one variation, the at least one permanent magnet 11 is fastened on a ring or sleeve outside at least one winding 12.

The rotating part Pt of the machine M1 includes at least one winding 12 which corresponds to an armature. In other words, during rotation, the at least one winding 12 receives an induction from the inductor, the permanent magnet 11, and transforms it into electricity, and more specifically into a sinusoidal alternating current, in the rotating part Pt of the turbomachine 50. The at least one winding 12 can refer to an electric coil.

The electric machine M1 therefore directly supplies an alternating electric current to the rotating part Pt of the turbomachine 50.

The electric machine M1, by using at least one permanent magnet 11, delivers a variable voltage, which varies with a rotational speed and whose effective value and frequency vary with a rotational speed of the rotating part Pt. In one aspect, the electric machine M1 comprises at least one pair of North-South permanent magnets.

The electrical machine M1 can, for example, be of the permanent magnet synchronous motor (PMSM) type with an external rotor, whose external part, comprising the at least one permanent magnet 11, is positioned on the fixed part Pf and whose internal part, comprising the at least one short-circuited winding 12, is positioned on the rotating part Pt.

The electric machine M1 is connected to an electrical power network 3 which is positioned in the rotating part Pt of the turbomachine 50. An electric current whose power is between 10 kW and 50 kW circulates through the electrical power network 3. The electric current circulating through the electrical power network 3 is generated by the electric machine M1 directly in the rotating part Pt.

The electrical power network 3 powers at least one function F1, F2 of the turbomachine 50. The functions F1, F2 are positioned on the rotating part Pt, and for example, in the vicinity of the windings 12, approximately a few millimeters away. In this way, it is not desirable to cause current to pass from the fixed part Pf to the rotating part Pt. The efficiency, weight, and volume of the turbomachine 50 are thus improved.

A function F1, F2 is any element of the turbomachine 50 that consumes electricity. A function F1, F2 can carry out a physical action on the turbomachine 50, such as heating, or a regulation or control action.

For example, the rotating part Pt comprises the functions F1, F2 such as fan pitch control, a small-pitch protection, or de-icing of a cone or the fan blades.

Moreover, the turbomachine 50 comprises an electrical control network 2 positioned in the rotating part Pt and connected to at least one power controller Ctrl positioned in the rotating part Pt. A control electrical current circulates through the electrical control network 2.

The electrical control network 2 allows the transmission of operating and regulation commands to the various functions F1, F2 of the rotating part Pt.

The power controller Ctrl generates and regulates the various functions F1, F2 of the rotating part Pt such as electrical protection or activation management of a function F1, F2.

The electrical control network 2 is electrically connected to a general regulation network 22 which is positioned in the fixed part Pf.

In one aspect, the general regulation network 22 is connected to the full authority digital engine controls (FADEC). The general regulation network 22 is a system that interfaces between a cockpit and the turbomachine 50 of the aircraft 100 to provide proper operation of the turbomachine 50.

The connection between the electrical control network 2 and the general regulation network 22 makes it possible to transmit data, but also allows information to be fed back, for example in the event of a failure on the turbomachine 50, and more particularly on a function F1, F2 of the rotating part Pt of the turbomachine 50.

Information is transmitted between the electrical control network 2 and the general regulation network 22 by a rotating data transformer 21.

The second variation illustrated in FIG. 4 differs from the first variation in that the electrical power network 3 is electrically connected, by means of a rotating power transformer 41, to an electrical power supply network 4 which is positioned in the fixed part Pf of the turbomachine 50.

Thus, when the electrical power network 3 is connected to the electrical power supply network 4, the electrical power network 3 comprises several power sources, on the one hand, from the machine M1 of the turbomachine 50, and on the other hand, from the electrical power supply network 4. There is therefore redundancy of the power sources. The electrical safety of the functions F1, F2 of the rotating part Pt is thus improved. For example, the small-pitch protection and the fan pitch control can be powered by independent power supplies.

Furthermore, when an electric current is generated by the electric machine M1 but no function F1, F2 of the rotating part Pt is in operation, the generated electric current can be fed into the electrical power supply network 4. This makes it possible to provide redundancy of electrical power supply on the electrical power supply network 4.

Finally, the turbomachine 50 may comprise a mechanical element for separating and disconnecting the electric machine M1 from a shaft A of the turbomachine 50. For example, the mechanical element for separating and disconnecting the electric machine is positioned in the rotating part of the turbomachine 50.

Indeed, in the event of an electrical failure of the electric machine M1 or the electrical power network 3, it is desired to have an element that allows the electric machine M1 to be mechanically disconnected.

Although the present disclosure has been described with reference to specific variations, it is obvious that modifications and changes can be made to these examples without departing from the general scope of the present disclosure as defined by the claims. In particular, individual features of the various illustrated/mentioned variations can be combined in additional variations. Therefore, the description and drawings should be considered in an illustrative rather than restrictive sense.

It is also obvious that all the features described with reference to a method are transposable, alone or in combination, to a device, and conversely, all the features described with reference to a device are transposable, alone or in combination, to a method.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A turbomachine for an aircraft, the turbomachine extending along an axis of rotation and comprising at least:
a rotating part rotating about the axis of rotation,
a fixed part fixed in rotation about the axis of rotation relative to the rotating part, the fixed part comprising a fan casing,
wherein the turbomachine comprises at least one permanent magnet synchronous electric machine,
the at least one permanent magnet synchronous electric machine comprising at least one permanent magnet positioned on the fixed part of the turbomachine and at least one winding positioned on the rotating part of the turbomachine, the at least one permanent magnet being arranged radially around the at least one winding,
the turbomachine comprising an electrical power network positioned in the rotating part, the electrical power network being connected to the at least one permanent magnet synchronous electric machine and being configured to circulate an electric current, the electrical power network being electrically connected to an electrical power supply network which is positioned in the fixed part of the turbomachine, and
the turbomachine comprising an electrical device positioned on the rotating part and being configured to be powered by the electric current.

2. The turbomachine according to claim 1, wherein the electrical power network is electrically connected to the electrical power supply network by means of a rotating power transformer.

3. The turbomachine according to claim 1, wherein the electrical power network is configured to provide an electric power greater than or equal to 10 kW and less than or equal to 50 kW.

4. The turbomachine according to claim 1, further comprising an electrical control network positioned in the rotating part and connected to at least one power controller positioned in the rotating part.

5. The turbomachine according to claim 4, wherein the electrical control network is electrically connected to a general regulation network which is positioned in the fixed part.

6. The turbomachine according to claim 1, further comprising a mechanical element for separating and disconnecting the at least one permanent magnet synchronous electric machine from a shaft of the turbomachine.

7. The turbomachine according to claim 1, wherein the at least one permanent magnet synchronous electric machine is positioned inside the fan casing.

8. An aircraft comprising the turbomachine according to claim 1.
